(19) United States
(12) Patent Application Publication
(10) Pub. No.: US 2014/0288757 A1
(43) Pub. Date: Sep. 25, 2014

(54) HYBRID VEHICLE

(71) Applicants: Takahiko Hirasawa, Toyota-shi (JP); Noritake Mitsutani, Toyota-shi (JP)

(72) Inventors: Takahiko Hirasawa, Toyota-shi (JP); Noritake Mitsutani, Toyota-shi (JP)

(73) Assignee: TOYOTA JIDOSHA KABUSHIKI KAISHA, Toyota-shi (JP)

(21) Appl. No.: 14/357,869

(22) PCT Filed: Nov. 14, 2011
(86) PCT No.: PCT/JP2011/076206

§ 371 Date: May 13, 2014

(51) Int. Cl. B60W 10/06; B60W 10/08; B60W 20/00

(52) U.S. Cl. CPC B60W 10/06; B60W 20/108; B60W 10/08; Y10S 903/93
USPC 701/22; 180/65.265; 903/930

(57) ABSTRACT

A hybrid vehicle according to one of embodiments of the present invention generates a driving torque using an internal combustion engine, an motor generator, and the like when a shift position is a driving position, the driving torque being determined based on a selected driving mode (e.g., a power mode to give priority to the power, and a normal mode to give priority to fuel consumption) and an accelerator operation amount. On the other hand, when the shift position is a neutral position, the vehicle maintains a rotational speed of the engine at a constant speed (including zero when the engine is stopped) regardless of the accelerator operation amount. When the accelerator operation amount becomes equal to or larger than an accelerator operation amount threshold while the neutral position is selected, the vehicle supplies information indicating that the neutral position is selected to a driver. The accelerator operation amount threshold is determined based on the driving mode.

### TECHNICAL FIELD

The present invention relates to a hybrid vehicle comprising, as a driving source, an internal combustion engine and an electric motor.

### BACKGROUND ART

A hybrid vehicle mounts, as a driving source for generating a driving force/power to run the vehicle, an internal combustion engine (hereinafter, simply referred to as an “engine”) and an electric motor. That is, the hybrid vehicle runs by transmitting a torque generated by at least one of the engine and the electric motor to a drive axle connected to drive wheels of the vehicle.

Meanwhile, similarly to a normal vehicle which mounts an engine only as the driving source, the hybrid vehicle comprises a shift position setting section (e.g., a shift lever and a shift lever position detecting section) so that a driver can select a shift position. The shift position includes a neutral position, and a driving (running) position which is selected when running the hybrid vehicle.

When the neutral position is selected, the hybrid vehicle stops an operation of the engine (i.e., maintains an engine rotational speed at “0”) since it is not necessary to apply the driving torque to the drive axle. Alternatively, when the neutral position is selected, the hybrid vehicle maintains the engine at a so-called “self sustaining operation state” in accordance with a charging state of a battery, a warming-up state of a catalyst, or the like, so as to generate an electric power using a power provided by the engine to charge the battery, or so as to expedite warming-up of the catalyst. In such a case, the hybrid vehicle maintains the engine rotational speed at a certain speed. In this manner, when the neutral position is selected, the hybrid vehicle maintains the engine rotational speed at the certain value (including “0”) which does not vary depending on an accelerator operation amount.

In the thus configured hybrid vehicle, for example, if the neutral position is actually selected even though the driver mistakenly recognizes that the driving position is selected, the engine rotational speed does not increase when the driver increases the accelerator operation amount in order to start or accelerate the vehicle. Accordingly, the driver may feel a feeling of strangeness, or may not be able to recognize that the shift position is the neutral position.

In view of the above, one of the conventional arts indicates and/or makes a sound to inform that the shift position is the neutral position when the accelerator operation amount becomes equal to or larger than a predetermined operation amount (accelerator operation amount threshold), in a case where the neutral position is selected and the engine is in the self-sustaining operation state. Accordingly, the driver can recognize that the shift position is the neutral position (e.g., refer to Patent Literature 1).

### CITATION LIST

### Patent Literature

[Patent Literature 1]
   Japanese Patent Application Laid-Open (kokai) No. 2010-241243

### SUMMARY OF THE INVENTION

There may be a case in which the hybrid vehicle is configured to allow the driver to select “driving (running) mode of the vehicle.” For example, the driving mode includes: a power mode to be selected when the driver desires a driving while giving priority to the power on a mountain road or the like; a normal mode to be selected for a usual (normal) driving; an economy mode which enables a driving while giving priority to the fuel consumption; or the like. In such a hybrid vehicle, the driving torque (i.e., drive axle torque) that the drive axle is made to generate with respect to a “certain accelerator operation amount” when a speed (vehicle speed) of the hybrid vehicle is a certain speed (including “0”) varies depending on the “selected driving mode.”

Accordingly, there may be a case where the notification is made to notify that the shift position is the neutral position, when the neutral position is selected and the accelerator operation amount becomes equal to or larger than the accelerator operation amount threshold, and thus, the driver changes the shift position into the driving position immediately after the notification. In such a case, an appropriate drive axle torque may be generated so that a desirable acceleration is achieved in one driving mode, whereas an excessively large drive axle torque may be generated so that an excessively large acceleration may be achieved and a shock may be occurred in another driving mode. The hybrid vehicle according to the present invention is made to solve the above described problem.

It should be noted that, in the description below, the “supply (notification) of a predetermined information concerning the shift position (e.g., information to have the driver recognize that the shift position is the neutral position)” which is carried out when the neutral position is selected and the accelerator operation amount becomes equal to or larger than the accelerator operation amount threshold is simply referred to as a “neutral position notification.”

An object of the present invention is to provide a hybrid vehicle which can apply an appropriate driving torque to the drive axle, by setting the accelerator operation amount threshold according to (depending on) the driving mode, even when the shift position is changed from the neutral position to the driving position immediately after the neutral position notification (is made), and thus, which can achieve a smooth start and/or a smooth acceleration.

The hybrid vehicle according to the present invention is a hybrid vehicle which comprises, as a driving source, an internal combustion engine and an electric motor.

The hybrid vehicle further comprises a shift position selecting section, a driving mode selecting section, an accelerator operation amount detecting section, a drive control section, and a shift position information supplying section.

The shift position selecting section is configured to allow/enable the driver to select, as a shift position, at least either one of a neutral position and a driving position.

The driving mode selecting section is configured to select allow/enable the driver to select one of two or more of driving modes. The accelerator operation amount detecting section is configured to detect an accelerator operation amount which is varied by the driver.

The drive control section is configured to:

(1) control the engine and the electric motor so as to apply a driving torque which varies in accordance with the driving mode selected by the driving mode selecting section and becomes larger as the detected accelerator operation amount becomes larger to a drive axle connected to drive wheels of the vehicle, when the driving position is selected; and
(2) control the engine and the electric motor irrespective of the detected accelerator operation amount in such a manner that no driving torque is applied to the drive axle, and a rotational speed of the engine becomes zero or a rotational speed irrelevant to the detected accelerator operation amount, when the neutral position is selected.

The shift position information supplying section is configured to supply information regarding the shift position to the driver, when the neutral position is selected and the detected accelerator operation amount becomes equal to or larger than an accelerator operation amount threshold.

Further, the shift position information supplying section is configured to vary/change the accelerator operation amount threshold in accordance with the selected driving mode.

According to the configuration described above, the accelerator operation amount threshold is varied/changed in accordance with the selected driving mode. Therefore, the drive axle torque generated when the shift position is changed into the driving position at a point in time of the neutral position notification can be a value which is not excessively large, whatever driving mode is selected (regardless of the driving mode). That is, it is possible to set the driving torque at an appropriate value in accordance with the driving mode under the driving position at a point in time at which the accelerator operation amount becomes larger than the accelerator operation amount threshold. As a result, when the driving position is selected at the point in time at which the accelerator operation amount becomes larger than the accelerator operation amount threshold (i.e., at the point in time of the neutral position notification), the hybrid vehicle which can achieve the smooth start and/or the smooth acceleration, regardless of the selected driving mode, is provided.

The two or more of the driving modes include a first driving mode and a second driving mode. The second driving mode is a driving mode in which the driving torque larger than the driving torque applied to the drive axle in the first mode is applied to the drive axle, when the driving position is selected and the accelerator operation amount becomes equal to an arbitrary accelerator operation amount. That is, the second driving mode is a mode in which the drive axle torque with respect to the same accelerator operation amount is set at a larger torque as compared to the first driving mode, and thus, is a “driving mode to give higher priority to the power (driving performance)” than the first driving mode.

Accordingly, the drive axle torque for a certain accelerator operation amount under the second driving mode is larger than the drive axle torque for that same certain accelerator operation amount under the first driving mode. In other words, the accelerator operation amount for/at which a creation drive axle torque is achieved under the first driving mode is larger than the accelerator operation amount for/at which the same creation drive axle torque is achieved under the second driving mode.

In view of the above, the shift position information supplying section is configured to set a first accelerator operation amount threshold which is the accelerator operation amount threshold to be set when the first driving mode is selected at a value larger than a second accelerator operation amount threshold which is the accelerator operation amount threshold to be set when the second driving mode is selected.

According to the configuration described above, the drive axle torque achieved when the shift position is changed from the neutral position into the driving position at the point in time of the neutral position notification in the case in which the first driving mode is selected can be made to become closer to the drive axle torque achieved when the shift position is changed from the neutral position into the driving position at the point in time of the neutral position notification in the case in which the second driving mode is selected.

Further, in this case, it is preferable that the shift position information supplying section be configured so as to set the first accelerator operation amount threshold and the second accelerator operation amount threshold, in such a manner that

the “driving torque applied to the drive axle when the accelerator operation amount becomes equal to the first accelerator operation amount threshold in a case where the first driving mode is selected and the driving position is selected” and

the “driving torque applied to the drive axle when the accelerator operation amount becomes equal to the second accelerator operation amount threshold in a case where the second driving mode is selected and the driving position is selected” are equal to each other.

According to the above configuration, the driving torque generated when the shift position is changed from the neutral position to the driving position at the point in time of the neutral position notification can be set at a constant value which achieves an appropriate acceleration, regardless of whether the first driving mode is selected or the second driving mode is selected.

Further, it is preferable that the hybrid vehicle of the present invention comprise a vehicle speed detecting section for detecting a vehicle speed which is a speed of the vehicle,

the drive control section be configured so as to control the engine and the electric motor in such a manner that the driving torque becomes smaller as the detected vehicle speed becomes higher, when the driving position is selected; and

the shift position information supplying section be configured so as to vary/change the accelerator operation amount threshold in such a manner that the accelerator operation amount threshold becomes larger as the detected vehicle speed becomes higher.

According to the above configuration, the driving torque which appropriately varies depending on the vehicle speed can be obtained, and the point in time of the neutral position notification while the vehicle is driving can be set at a point in time at which an excessively large acceleration does not generated in a case in which the shift position is changed from the neutral position to the driving position at the point in time of that notification. In addition, since the accelerator operation amount threshold becomes larger as the vehicle speed becomes higher, it can be prevented that the neutral position notification is unnecessarily carried out while the vehicle is running.

Other objects, features, and advantages of the present invention will be readily understood from the following description of each of embodiments of the present invention with reference to the accompanying drawings.

### BRIEF DESCRIPTION OF THE DRAWINGS

FIG. 1 is a schematic diagram of a hybrid vehicle according to an embodiment of the present invention.

FIG. 2 is a graph showing a relationship between an accelerator operation amount and a vehicle requesting torque (requested driving force) in each of driving modes.

FIG. 3 is a graph showing a relationship between “an accelerator operation amount AP and a vehicle speed SPD” and the “vehicle requesting torque” in each of the driving modes.

FIG. 4 is a graph showing an optimum engine operation line with respect to an engine generating torque and an engine rotational speed.

FIG. 5 is a collinear diagram of a planetary gear device shown in FIG. 1.

FIG. 6 is a graph showing a relationship between the accelerator operation amount and the vehicle requesting torque in each of the driving modes.

FIG. 7 is a flowchart showing a routine executed by a CPU of a power management ECU shown in FIG. 1.

FIG. 8 is graph showing a relationship between a vehicle speed and a vehicle speed correction amount of threshold.

FIG. 9 is a flowchart showing a routine executed by the CPU of the power management ECU shown in FIG. 1.

### DESCRIPTION OF THE EMBODIMENT

A hybrid vehicle of an embodiment according to the present invention will next be described with reference to the drawings. It can be said that the hybrid vehicle is provided with a neutral position notification apparatus/device as is clear from the following descriptions.

### (Construction)

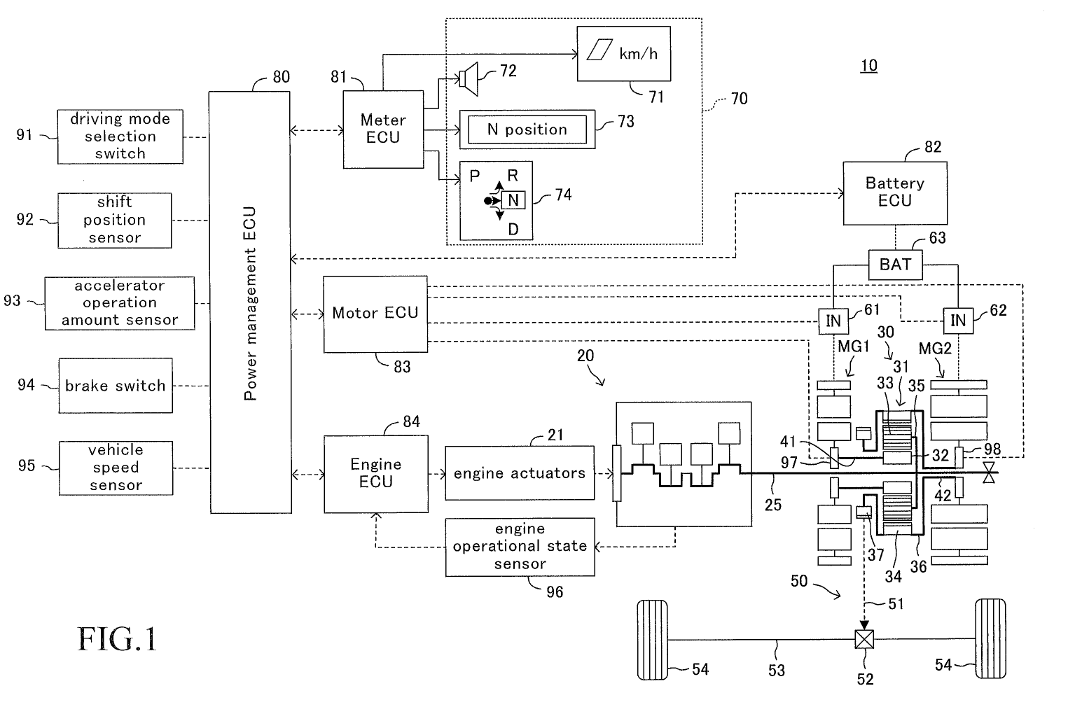

As shown in FIG. 1, the hybrid vehicle 10 of the embodiment according to the present invention comprises a motor generator MG1, a motor generator MG2, an internal combustion engine 20, a power distribution mechanism 30, a power transmission mechanism 50, a first inverter 61, a second inverter 62, a battery 63, a combination meter 70, a power management ECU, a meter ECU 81, a battery ECU 82, a motor ECU 83, and an engine ECU 84. It should be noted that an ECU stands for an Electric Control Unit, which is an electronic control circuit comprising a micro-computer as a main component that includes a CPU, a ROM, a RAM, an interface, and the like.

The motor generator MG1 is a synchronous generator-motor which can function as a generator and an electric motor. The motor generator MG1 is referred to as a first motor generator MG1, for convenience. The first motor generator MG1 comprises an output shaft (hereinafter, referred to as a “first shaft”) 41.

The motor generator MG2 is a synchronous generator-motor which can function as a generator and an electric motor, similarly to the first motor generator MG1. The motor generator MG2 is referred to as a second motor generator MG2, for convenience. The second motor generator MG2 comprises an output shaft (hereinafter, referred to as a “second shaft”) 42.

The internal combustion engine (engine) 20 is a 4 cycle, spark-ignition, multi-cylinder internal combustion engine. The engine 20 comprises well-known engine actuators 21. For example, the engine actuators 21 includes a fuel supply apparatus including fuel injectors, a spark ignition device including spark plugs, an actuator for varying a throttle valve opening, a variable intake valve timing control unit (VVT), or the like. The engine 20 is configured so as to vary its output torque and an engine rotational speed (and thus, its output power), by changing an fuel injection amount using the fuel supply apparatus, or by changing an intake air amount through varying an opening degree of the throttle valve provided in an unillustrated intake air passage using the throttle valve actuator. The engine 20 generates a torque transmitted to a crank shaft 25 which is an output shaft of the engine 20. It should be noted that a three-way catalytic unit (catalyst) is disposed in an unillustrated exhaust passage of the engine 20.

The power distribution mechanism 30 comprises a well-known planetary gear device 31. The planetary gear device 31 includes a sun gear 32, a plurality of planetary gears 33, and a ring gear 34.

The sun gear 32 is connected to the first shaft 41 of the first motor generator MG1. Therefore, the first motor generator MG1 can output a torque to the sun gear 32. Further, the first motor generator MG1 can be rotationally driven by a torque which is input to the first motor generator MG1 (first shaft 41) from the sun gear 32. The first motor generator MG1 can generate an electric power by being rotationally driven by the torque input into the first motor generator MG1 from the sun gear 32.

Each of a plurality of the planetary gears 33 meshes with the sun gear 32 and the ring gear 34. An axis of rotation of the planetary gear 33 is provided at the planetary carrier 35. The planetary carrier 35 is rotatably supported coaxially with the sun gear 32. Accordingly, the planetary gear 33 can revolve around the sun gear 32 while rotating. The planetary carrier 35 is connected to the crank shaft 25 of the engine 20. Thus, the planetary gear 33 can be rotationally driven by a torque which is input to the planetary carrier 35 from the crank shaft 25.

The ring gear 34 is rotatably supported coaxially with the sun gear 32.

As described above, the planetary gear 33 meshes with the sun gear 32 and the ring gear 34. Therefore, when a torque is input from the planetary gear 33 to the sun gear 32, the sun gear 32 is rotationally driven by the torque. When a torque is input from the planetary gear 33 to the ring gear 34, the ring gear 34 is rotationally driven by the torque. To the contrary, when a torque is input from the sun gear 32 to planetary gear 33, the planetary gear 33 is rotationally driven by the torque. When a torque is input from the ring gear 34 to planetary gear 33, the planetary gear 33 is rotationally driven by the torque.

The ring gear 34 is connected to the second shaft 42 of the second motor generator MG2 through a ring gear carrier 36. Accordingly, the second motor generator MG2 can output a torque to the ring gear 34. In addition, the second motor generator MG2 can be rotationally driven by a torque which is input from the ring gear 34 to the second motor generator MG2 (second shaft 42). The second motor generator MG2 can generate an electric power by being rotationally driven by the torque which is input from the ring gear 34 to the second motor generator MG2.

Further, the ring gear 34 is connected to an output gear 37 through the ring gear carrier 36. Accordingly, the output gear 37 can be rotationally driven by a torque which is input from the ring gear 34 to the output gear 37. The ring gear 34 can be rotationally driven by a torque which is input from the output gear 37 to the ring gear 34.

The power transmission mechanism 50 includes a gear train 51, a differential gear 52, and a drive axle (drive shaft) 53.

The gear train 51 power-transmittably connects between the output gear 37 and the differential gear 52. The differential gear 52 is connected to the drive axle (shaft) 53. Drive wheels 54 are fixed to both ends of the drive axle 53. The torque from the output gear 37 is therefore transmitted to the drive wheels 54 through the gear train 51, the differential gear 52, and the drive axle 53. The hybrid vehicle 10 can run using that torque transmitted to the drive wheels 54.

The first inverter 61 is electrically connected with the first motor generator MG1 and the battery 63. Accordingly, when the first motor generator MG1 generates the electric power, the electric power generated by the first motor generator MG1 is supplied to the battery 63 through the first inverter 61. To the contrary, the first motor generator MG1 is rotationally driven by an electric power supplied from the battery 63 through the first inverter 61 to the first motor generator MG1.

The second inverter 62 is electrically connected with the second motor generator MG2 and the battery 63. Accordingly, the second motor generator MG2 is rotationally driven by an electric power supplied from the battery 63 through the second inverter 62 to the second motor generator MG2. To the contrary, when the second motor generator MG2 generates the electric power, the electric power generated by the second motor generator MG2 is supplied to the battery 63 through the second inverter 62.

It should be noted that the electric power generated by the first motor generator MG1 can be directly supplied to the second motor generator MG2, and the electric power generated by the second motor generator MG2 can be directly supplied to the first motor generator MG1.

The combination meter 70 includes a speed indicator (meter) 71, a sound device 72, a message indicator (indicator for neutral position notification) 73, a shift position indicator 74, and the like. They are connected with the meter ECU 81, and each of them carries out an indication or making a sound in response to an instruction signal from the meter ECU 81.

The speed indicator 71 is a display device which displays the vehicle speed.

The sound device 72 is a speaker device which notifies the driver by a voice sound that “the current/present shift position is the neutral position” when a specific condition described later is satisfied. It should be noted that the sound device 72 may be a mere warning/alarm sound generation device (e.g., buzzer).

The message indicator 73 is a display device which notifies the driver by a text display that “the current/present shift position is the neutral position” when the specific condition described later is satisfied.

The shift position indicator 74 is a display device which indicates a current/present shift position.

The power management ECU 80 (hereinafter, expressed as “PMECU 80”) is information exchangeably connected with the meter ECU 81, the battery ECU 82, the motor ECU 83, and the engine ECU 84 through communication.

The PMECU 80 is connected with a driving mode selection switch 91, a shift position sensor 92, an accelerator operation amount sensor 93, a brake switch 94, a vehicle speed sensor 95, and the like, and is configured to receive output signals generated by those sensors.

The driving mode selection switch 91 is configured to generate an output signal indicating/indicative of a driving mode selected by the driver. In the present example, the driving mode includes a normal mode, a power mode, and an economy mode. It should be noted that the driving mode may include two or more modes. The driving mode will be described later.

The shift position sensor 92 is configured to generate an output signal indicating/indicative of a shift position selected using an unillustrated shift lever which is provided so as to be operated by the driver in the neighborhood of a driver's seat of the hybrid vehicle 10. In the present example, the shift position includes P (parking position), R (reverse position), N (neutral position), and D (driving position).

The accelerator operation amount sensor 93 is configured to generate an output signal indicating/indicative of an operation amount (accelerator operation amount AP) of an unillustrated accelerator pedal provided so as to be operated by the driver.

The brake switch 94 generates an output signal indicating that the brake pedal is in an operation condition when an unillustrated brake pedal provided so as to be operated by the driver is operated. The vehicle speed sensor 95 generates an output signal indicative of the vehicle speed SPD.

The PMECU 80 is configured to generate a signal indicative of a state SOC (remaining battery level) of the battery 63, which is calculated by the battery ECU 82.

The PMECU 80 is configured to receive, through the motor ECU 83, a signal indicative of a rotational speed of the first motor generator MG1 (hereinafter, referred to as a “first MG rotational speed Nm1”) and a signal indicative of a rotational speed of the second motor generator MG2 (hereinafter, referred to as a “second MG rotational speed Nm2”).

It should be noted that the first MG rotational speed Nm1 is calculated, by the motor ECU 83, based on an “output value of a resolver 97 which is disposed in the first motor generator MG1 and generates an output value corresponding to a rotational angle of a rotor of the first motor generator MG1. Similarly, the second MG rotational speed Nm2 is calculated, by the motor ECU 83, based on an “output value of a resolver 98 which is disposed in the second motor generator MG2 and generates an output value corresponding to a rotational angle of a rotor of the second motor generator MG2.

The PMECU 80 is configured to receive, through the engine ECU 84, output signals indicative of an engine operation state, the signals being detected by engine operational state sensor 96. The output signals indicative of the engine operation state includes an engine rotational speed Ne, a throttle valve opening TA, a cooling water temperature THW of the engine, or the like.

The motor ECU 83 is connected with the first inverter 61 and the second inverter 62, and is configured to supply instruction signals to those inverters based on instructions from the PMECU 80. Accordingly, the motor ECU 83 is configured to control the first motor generator MG1 using the first inverter 61, and to control second motor generator MG2 using the second inverter 62.

The engine ECU 84 is configured to supply instruction signals to the engine actuators 21 based on the instructions from the PMECU 80 and the engine operational state sensor 96, so as to control the engine 20.

### (Outline of Operation)

In the thus configured hybrid vehicle 10, the PMECU 80 determines a “torque to be generated at the rotating shaft of the ring gear 34 (hereinafter, simply referred to as a “ring gear requesting torque Tr*”) based on at least the accelerator operation amount AP and the selected driving mode when the shift position is in the driving position. The ring gear requesting torque Tr* corresponds to a vehicle requesting torque (user requesting torque, requested driving force) Treq, which is a torque required the drive axle 35 of the vehicle 10 to generate.

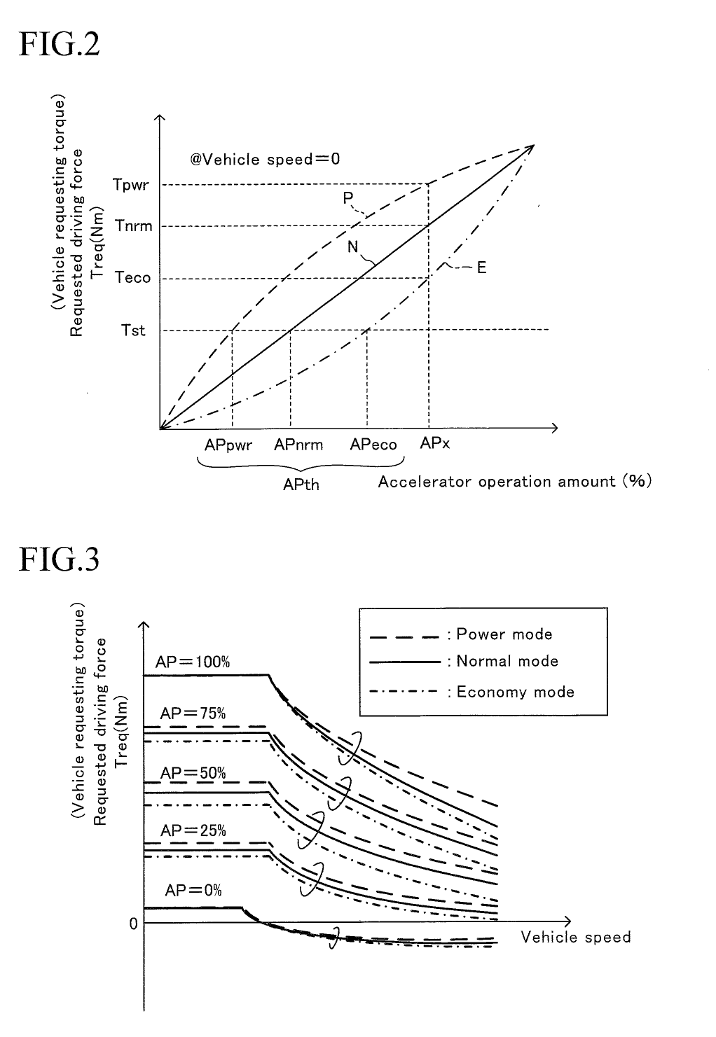

FIG. 2 shows a relationship between the accelerator operation amount AP and the vehicle requesting torque Treq, in each of the driving modes. In FIG. 2, a broken line P indicates the relationship between the accelerator operation amount AP and the vehicle requesting torque Treq, when the driving mode is the power mode. A solid line N indicates the relationship between the accelerator operation amount AP and the vehicle requesting torque Treq, when the driving mode is the normal mode. Further, an alternate long and short dash line E indicates the relationship between the accelerator operation amount AP and the vehicle requesting torque Treq, when the driving mode is the economy mode.

As understood from FIG. 2, the vehicle requesting torque Treq is set so as to become larger as the accelerator operation amount AP becomes larger, in each of the driving modes. In addition, if the accelerator operation amount AP is equal to a “certain value APx”, the vehicle requesting torque Treq is set at the value Tpwr when the power mode is selected, the vehicle requesting torque Treq is set at the value Tnrm when the normal mode is selected, and the vehicle requesting torque Treq is set at the value Teco when the economy mode is selected. Regardless of the magnitude of the value APx, a relationship is always maintained that the value Tpwr is equal to or larger than the value Tnrm, and the value Tnrm is equal to or larger than the Teco.

In this manner, the vehicle requesting torque Treq is set so as to become larger as the accelerator operation amount AP becomes larger in each of the driving modes. The vehicle requesting torque Treq with respect to (for) the same accelerator operation amount AP is set so as to become the largest value when the power mode is selected, become the middle value when the normal mode is selected, and become the smallest value when the economy mode is selected.

In actuality, it should be noted that the vehicle requesting torque Treq is set based on “the accelerator operation amount AP and the vehicle sepeed SPD” and “the driving mode”, as shown in FIG. 3. As understood from FIG. 3, in each of the driving modes, the vehicle requesting torque Treq does not vary depending on the vehicle speed SPD and becomes larger as the accelerator operation amount AP becomes larger when the vehicle speed SPD is in a low speed region which is equal to or smaller than a predetermined value. That is, the relationship between the accelerator operation amount AP and the vehicle requesting torque Treq when the vehicle speed SPD is in the low speed region is as shown in FIG. 2. In addition, in each of the driving modes, the vehicle requesting torque Treq is set so as to become smaller as the vehicle speed SPD becomes larger when the vehicle speed SPD is in a high speed region which is equal to or larger than a predetermined value. It should be noted, however, that the relationship is still maintained that the value Tpwr is equal to or larger than the value Tnrm, and the value Tnrm is equal to or larger than the Teco, even when the vehicle speed SPD is in the high speed region.

That is, the hybrid vehicle 10 can run under each of two or more of the driving modes, which includes a first driving mode (e.g., the normal mode) and a second driving mode (e.g., the power mode). When the driving position is selected, and the accelerator operation amount AP is an arbitrary certain operation amount, the second mode is a driving mode in which a driving torque larger than a driving torque applied to the drive axle 53 in the first driving mode is applied to the drive axle 53.

In the meantime, there is a proportional relation between the torque supplied to (acting on) the drive axle 53 (driving torque, drive axle torque) and the torque applied to (acting on) the rotation shaft of the ring gear 34. Accordingly, the PMECU 80 includes tables (torque map MapTr*(AP, SPD)) for each of the driving modes, and stores those in the ROM, each of the tables including data obtained by converting the above described relationship between/among “the vehicle speed SPD, the accelerator operation amount AP, and the vehicle requesting torque Treq” into a relationship between/among “the vehicle speed SPD, the accelerator operation amount AP, and the ring gear requesting torque Tr*.” The PMECU 80 determines the ring gear requesting torque Tr* by applying “the actual accelerator operation amount AP and the actual vehicle speed SPD” to “the torque map MapTr*(AP, SPD) corresponding to the selected driving mode.”

Meanwhile, the power that the drive axle 53 is required to generate is a value proportional to a product (Treq·SPD) of the vehicle requesting torque Treq and the actual vehicle speed SPD, and that value is equal to a product (Tr*·Nr) of the ring gear requesting torque Tr* and the rotational speed Nr of the ring gear 34. Hereinafter, the product Tr*·Nr is referred to as a “requested power Pr*.” It should be noted that the ring gear 34 is connected to the second shaft 42 of the second motor generator MG2 without passing through a reducer in the present example. Accordingly, the rotational speed Nr of the ring gear 34 is equal to the second MG rotational speed Nm2. If the ring gear 34 is connected to the second shaft 42 through a reducer, the rotational speed Nr of the ring gear 34 is equal to a value (Nm2/Gr) obtained by dividing the second MG rotational speed Nm2 by a gear ratio Gr of the reducer.

The PMECU 80 operates the engine 20 in such a manner that the engine 20 generates a power equal to the requested power Pr*, and an operating efficiency of the engine 20 is the highest/optimum.

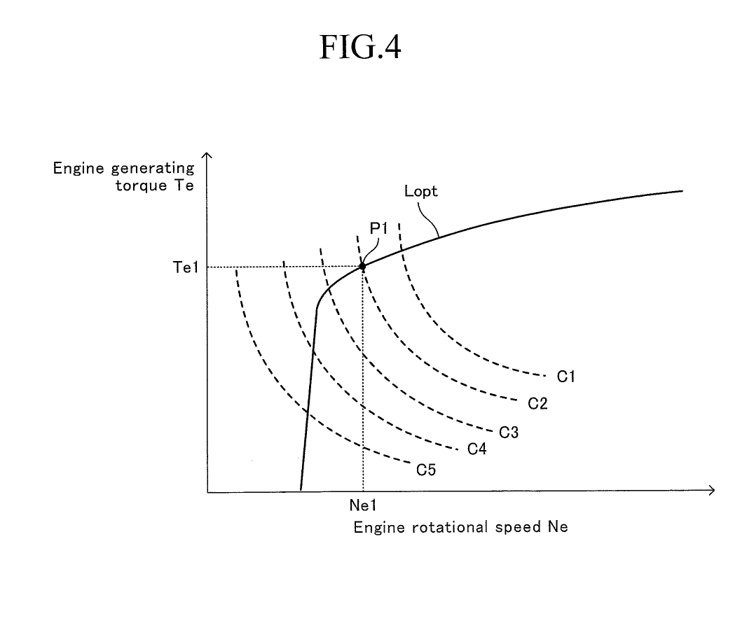

More specifically, an engine operation point at which the operating efficiency of the engine 20 (fuel consumption) becomes optimum when the engine outputs a certain power from the crank shaft 25 is obtained, as an optimum engine operation point, in advance through experiments or the like for each of the power. Thus obtained optimum engine operation points are plotted on a graph defined by the engine generating torque Te and the engine rotational speed Ne. A line connecting between those plotted points is obtained as the optimum engine operation line. Thus obtained optimum engine operation line is shown by a solid line Lopt in FIG. 4. Each of a plurality of lines C1-C5 shown by a broken line in FIG. 4 is a line (equal power line) obtained by connecting engine operation points at which the engine 20 can generate the same power from the crank shaft 25.

PMECU 80 stores a table (map), which correlates “the engine generating torque Te and the engine rotational speed Ne” for each of the optimum engine operation points with the power of the engine 20 at each of the optimum engine operation points, in the ROM. After the PMECU 80 determines the requested power Pr*, the PMECU 80 searches out the optimum engine operation point at which a power equal to the requested power Pr* is obtained, and determines “the engine generating torque Te and the engine rotational speed Ne” which correspond to the searched optimum engine operation point, as “a target engine generating torque Te* and a target engine rotational speed Ne*”, respectively. For example, when the requested power Pr* is equal to a power corresponding to the line C2 in FIG. 4, the engine generating torque Te for a point P1 at the intersection of the line C2 with the solid line Lopt is determined as the target engine generating torque Te*, and the engine rotational speed Ne for the point P1 is determined as the target engine rotational speed Ne*.

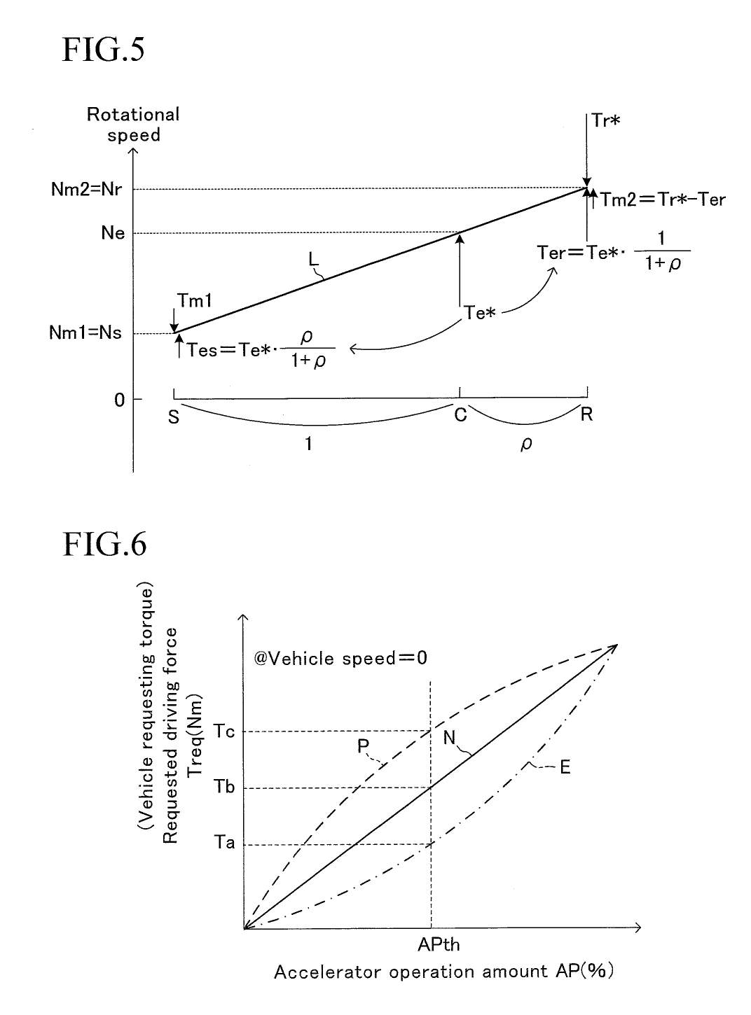

On the other hand, a relationship between rotational speeds of the gears of the planetary gear device 31 is represented by a well-known collinear diagram shown in FIG. 5. A straight line in the collinear diagram is referred to as an operation collinear line L. According to the collinear diagram, the rotational speed Ns of the sun gear 32 can be obtained by a formula (1) described below. “ρ” in the formula (1) is a ratio of the number of gear teeth of the sun gear 32 to the number of gear teeth of the ring gear 34 (p=the number of gear teeth of the sun gear 32/the number of gear teeth of the ring gear 34). It should be noted that, as understood from the operation collinear line L, the formula (1) is obtained based on a proportional relation in which a ratio (=(Ne−Ns)/(Nr−Ns)) of a difference (Ne−Ns) between the engine rotational speed Ne and the rotational speed Ns of the sun gear 32 to a difference (Nr−Ns) between the rotational speed Nr of the ring gear 34 and the rotational speed Ns of the sun gear 32 is equal to a ratio (=1/(1+ρ)) of 1 to a value (1+p).

Ns=Nr−(Nr−Ne)·(1+ρ)/ρ (1)

In view of the above, the PMECU 80 calculates the target rotational speed Ns* of the sun gear 32, by applying the actual rotational speed Nr of the ring gear 34 and the target engine rotational speed Ne* to the above formula (1). When the sun gear 32 rotates at the target rotational speed Ns*, the engine rotational speed Ne coincides with the target engine rotational speed Ne*.

Further, when a torque equal to the target engine generating torque Te* is generated at the crank shaft 25 (that is, when the engine generating torque is Te*), the engine generating torque Te* is converted by the planetary gear device 31 so as to become a torque Tes represented by a formula (2) described below and a Ter represented by a formula (3) described below. The torque Tes acts on (is supplied to) the rotational shaft of the sun gear 32. The torque Ter acts on (is supplied to) the rotational shaft of the ring gear 34.

Tes=Te*·(ρ/(1+ρ)) (2)

Ter=Te*·(1/(1+ρ)) (3)

In order for the operation collinear line to be sable, an equilibrium of force on the operation collinear line must be achieved. Thus, a torque Tm1, which has the same magnitude as the magnitude of the torque Tes obtained according to the formula (2) described above, and whose direction is opposite to the direction of the torque Tes, should be applied to the rotational shaft of the sun gear 32, and a torque Tm2 (represented by a formula (4) described below), which corresponds to a shortage of the torque Ter for the ring gear requesting torque Tr* that is obtained according to the formula (3) described above, should be applied to the rotational shaft of the ring gear 34. The torque Tm1 can be generated by the first motor generator MG1, and the torque Tm2 can be generated by the second motor generator MG2.

Tm2=Tr*·Ter (4)

In view of the above, the PMECU 80 adopts the above described torque Tm1 as an MG1 instruction torque Tm1*, and adopts the above described torque Tm2 as an MG2 instruction torque Tm2* which is an instruction torque for the second motor generator MG2. Further, the PMECU 80 calculates a value by adding a feedback amount PID (NS*−Nm1) to the above described MG1 instruction torque Tm1*, and adopts that value as the MG1 instruction torque Tm* which is a final instruction torque for the first motor generator MG1, the feedback amount PID (NS*−Nm1) corresponding to a difference between the “target rotational speed Ns* of the sun gear 32” and the “rotational speed Nm1 of the first motor generator MG1 equal to the actual rotational speed Ns of the sun gear 32.” That is, the target rotational speed Ns* of the sun gear 32 is used as a target value (hereinafter referred to as a target MG1 rotational speed Nm1*) of the rotational speed Nm1 of the first motor generator MG1.

Thereafter, the PMECU 80 controls the first inverter 61 based on the MG1 instruction torque Tm1* so as to have the generating torque of the first motor generator MG1 become equal to the MG1 instruction torque Tm1*, controls the second inverter 62 based on the MG2 instruction torque Tm2* so as to have the generating torque of the first motor generator MG2 become equal to the MG2 instruction torque Tm2*, and controls the engine 20 so as to have the engine generating torque become equal to the target engine generating torque Te*. It should be noted that, in this case, the control of the engine 20 is carried out by varying the throttle valve opening, or by varying an amount of fuel (fuel injection amount) supplied from the injectors. In this manner, the engine 20 is operated at the optimum engine operation point.

Note, however, the PMECU 80 stops the operation of the engine (engine rotational speed Ne=0) or has the engine 20 operate under an idling operating state for the self-sustaining operation in accordance with a condition, and controls the second motor generator MG2 so as to have the second motor generator MG2 generate all of the requested power Pr*, when the engine 20 cannot be operated at the optimum engine operation point since the requested power Pr* is smaller than a predetermined power Prth, such as when the vehicle is started, when the engine is operated under a stable running state at a relatively low speed, when the engine is moderately accelerated while the engine rotational speed is relatively low, or the like. In addition, even when the engine 20 can be operated at the optimum engine operation point, there is a case in which the engine generating torque becomes smaller than the target engine generating torque Te*, because the operating state of the engine 20 cannot immediately change when the target engine generating torque Te* changes owing to a change in the ring gear requesting torque Tr*. In such a case, the PMECU 80 controls the second motor generator MG2 in such a manner that a shortage with respect to the ring gear requesting torque Tr* is compensated until the engine 20 is operated at the optimum engine operation point.

It should be noted that the operation described above is carried out when the state SOC (remaining battery level) of the battery 63 is equal to or higher than a predetermined value. When the remaining battery level SOC is lower than the predetermined value, the requested power Pr* is changed into a value larger than the requested power Pr* when the remaining battery level SOC is higher than the predetermined value, so that a control is carried out in which the engine 20 makes the first motor generator MG1 generate the electric power.

In contrast, when the shift position is the neutral position, the PMECU 80 stops the operation of the engine (engine rotational speed Ne=0) or has the engine 20 operate under the idling operating state for the self sustaining operation in accordance with a condition (e.g., when the engine cooling water temperature THW is low so that the warming-up of the catalyst should be promoted/expedited), and sets both the MG1 instruction torque Tm1* and the MG2 instruction torque Tm2* to/at “0.”

In the hybrid vehicle 10, the engine rotational speed Ne does not increase, when the driver mistakenly recognizes that the driving position is selected even though the neutral position is actually selected, and when the driver increases the accelerator operation amount AP in order to start or accelerate the vehicle 10.

In view of the above, the PMECU 80 notify/inform the driver that the shift position is the neutral position by displaying the message on the message indicator 73 and makes a sound of that message, when the accelerator operation amount AP becomes equal to or larger than an accelerator operation amount threshold APth, in a case where the neutral position is selected. This type of the notifying operation is referred to as a “neutral position notification.” However, the following problem occurs when the accelerator operation amount threshold APth is constant regardless of the driving mode.

That is, for example, as shown in FIG. 6, in a case in which the accelerator operation amount threshold APth is a constant value, and when the driver changes the shift position into the driving position immediately after the neutral position notification was made so that the driver noticed that the “shift position is the neutral position”, the requested driving force (vehicle requesting torque, and therefore, torque acting on the drive axle) Treq is equal to a value Ta if the driving mode is the economy mode, the requested driving force Treq is equal to a value Tb if the driving mode is the normal mode, and the requested driving force Treq is equal to a value Tc if the driving mode is the power mode.

In this case, each of the value Tb and the value Tc is larger than the value Ta. Therefore, if the value Ta is set at a value such that a shock does not become excessively large when the hybrid vehicle 10 starts to run (such that the driver does not feel uncomfortable), an excessively large acceleration shock occurs when the driving mode is the normal mode or the power mode.

In view of the above, the hybrid vehicle 10 according to the present embodiment changes/varies the “accelerator operation amount threshold Apth which determines a point in time of the neutral position notification” in accordance with (depending on) the “selected driving mode.” More specifically, as shown in FIG. 2, the accelerator operation amount threshold APth is varied in accordance with (depending on) the driving mode, such that the requested driving force Treq becomes a “relatively large value Tst as long as the requested driving force Treq does not provide the excessively large shock to the hybrid vehicle 10”, even if the shift position is changed into the driving position immediately after the neutral position notification was made.

That is, in the example shown in FIG. 2, the accelerator operation amount threshold APth is set to/at an accelerator operation amount APpwr corresponding to a point at which the requested driving force Treq coincides with the value Tst on the broken line P if the power mode is selected, is set to/at an accelerator operation amount APnrm corresponding to a point at which the requested driving force Treq coincides with the value Tst on the solid line N if the normal mode is selected, and is set to/at an accelerator operation amount APeco corresponding to a point at which the requested driving force Treq coincides with the value Tst on the alternate long and short dash line E if the economy mode is selected. That is, the accelerator operation amount threshold APth is varied/set depending on the selected driving mode. As a result, regardless of the driving mode, the requested driving force Treq becomes the substantially constant value Tst (each of the requested driving force Treq becomes the same value as each other under all of the driving modes) even when the shift position is changed into the driving position from the neutral position immediately after the neutral position notification was made. Accordingly, the large shock does not occur in the vehicle since the requested driving force Treq does not become excessively large.

### (Actual Operation)

An actual operation of the hybrid vehicle 10 will next be described. The processes described below are executed by a CPU of the PMECU 80 (hereinafter, simply referred to as a “CPU”).

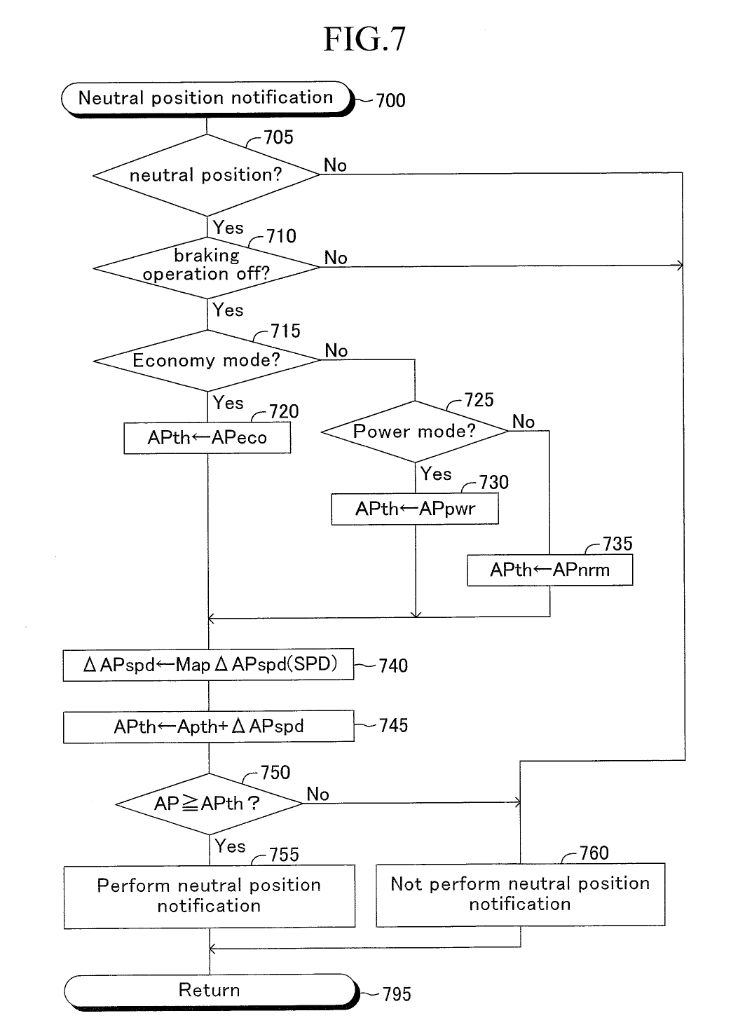

The CPU is configured so as to repeatedly execute a “neutral position notification routine” shown by a flowchart in FIG. 7, every elapse of a predetermined time. Accordingly, at an appropriate point in time, the CPU starts processing from step 700 of FIG. 7 to proceed to step 705, at which the CPU determines whether or not the current/present shift position is the neutral position.

When the current shift position is the neutral position, the CPU makes a “Yes” determination at step 705 to proceed to step 710, at which the CPU determines whether or not the brake pedal is not pressed/operated (whether or not the braking operation is not being performed).

When the brake pedal is not pressed/operated, the CPU makes a “Yes” determination at step 710 to proceed to step 715, at which the CPU determines whether or not the currently selected driving mode is the economy mode. If the currently selected driving mode is the economy mode, the CPU makes a “Yes” determination at step 715 to proceed to step 720, at which the CPU sets the accelerator operation amount threshold APth to/at the accelerator operation amount threshold APeco for the economy mode (refer to FIG. 2).

In contrast, if the currently selected driving mode is not the economy mode, the CPU makes a “No” determination at step 715 to proceed to step 725, at which the CPU determines whether or not the currently selected driving mode is the power mode. If the currently selected driving mode is the power mode, the CPU makes a “Yes” determination at step 725 to proceed to step 730, at which the CPU sets the accelerator operation amount threshold APth to/at the accelerator operation amount threshold APpwr for the power mode (refer to FIG. 2).

When the currently selected driving mode is neither the economy mode nor the power mode, the currently selected driving mode is the normal mode. In this case, the CPU makes a “No” determination at step 725 to proceed to step 735, at which the CPU sets the accelerator operation amount threshold APth to/at the accelerator operation amount threshold APnrm for the normal mode. It should be noted that, as described above, the accelerator operation amount threshold APpwr for the power mode is equal to or smaller than the accelerator operation amount threshold APnrm for the normal mode, and the accelerator operation amount threshold APnrm for the normal mode is equal to or smaller than the accelerator operation amount threshold APeco for the economy mode.

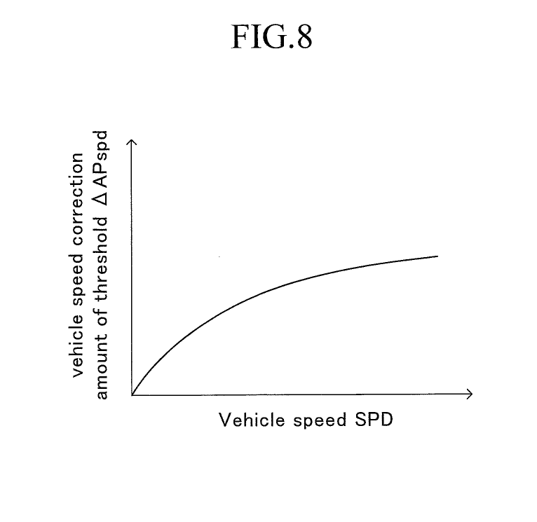

The CPU proceeds to step 740 from any one of step 720, step 730, and step 735 so as to obtain a vehicle speed correction amount of threshold ΔAPspd. More specifically, the PMECU 80 stores, in a form of a table Map ΔAPspd (SPD), a relationship between the vehicle speed SPD and the vehicle speed correction amount of threshold ΔAPspd, shown in FIG. 8 in the ROM. The CPU applies an actual vehicle speed SPD to the table Map ΔAPspd (SPD) so as to calculate the vehicle speed correction amount of threshold ΔAPspd. According to the table MapΔAPspd (SPD), the vehicle speed correction amount of threshold ΔAPspd is obtained so as to become larger as the vehicle speed SPD becomes larger. The reason for this will be described later. It should be noted that the PMECU 80 may store the relationship between the vehicle speed SPD and the vehicle speed correction amount of threshold ΔAPspd, shown in FIG. 8, in the ROM, in a form of a function.

Subsequently, the CPU proceeds to step 745 so as to store, as a final accelerator operation amount threshold APth, a value obtained by adding the vehicle speed correction amount of threshold ΔAPspd to the accelerator operation amount threshold APth which is set at one of step 720, step 730, and step 735.

As a result, the accelerator operation amount threshold APth is corrected with the vehicle speed correction amount of threshold ΔAPspd such that the accelerator operation amount threshold APth becomes larger as the vehicle speed becomes higher. This is because, as shown in FIG. 3, the requested driving force Treq becomes smaller as the vehicle speed becomes higher even when the driving mode is kept unchanged (e.g., power mode).

Subsequently, the CPU proceeds to step 750 so as to determine whether or not the current/present accelerator operation amount AP is equal to or larger than the accelerator operation amount threshold APth obtained at step 745. When the current accelerator operation amount AP is equal to or larger than the accelerator operation amount threshold APth obtained at step 745, the CPU makes a “Yes” determination at step 750 to proceed to step 755, at which the CPU carries out the above described neutral position notification using “the message indicator 73 and/or the sound device 72.” Thereafter, the CPU proceeds to step 795 to end the present routine tentatively.

In contrast, when the current accelerator operation amount AP is smaller than the accelerator operation amount threshold APth obtained at step 745, the CPU makes a “No” determination at step 750 to proceed to step 760, at which the CPU stops (or prohibits) the above described neutral position notification. It should be noted that, if the neutral position notification is not being carried out at this point in time, the CPU stops the neutral position notification for confirmation. Thereafter, the CPU proceeds to step 795 to end the present routine tentatively.

It should be noted that, if the shift position is not the neutral position when the CPU executes the process of step 705, the CPU makes a “No” determination at step 705 to proceed to step 760, at which the CPU stops (or prohibits) the neutral position notification, and thereafter, the CPU proceeds to step 795 to end the present routine tentatively.

Further, if the brake pedal is being pressed (i.e., the brake is being operated) when the CPU executes the process of step 710, the CPU makes a “No” determination at step 710 to proceed to step 760, at which the CPU stops (or prohibits) the neutral position notification, and thereafter, the CPU proceeds to step 795 to end the present routine tentatively.

The reason why the neutral position notification is stopped during the braking operation in the above described manner is that (1) it is unlikely that the driver increases the accelerator operation amount AP while the driver is pressing/operating the brake, (2) the acceleration of the vehicle does not become large even if the shift position is changed from the neutral position to the driving position, and so on. Note, however, step 710 may be omitted. In this case, the CPU proceeds to step 715 when the CPU makes a “Yes” determination at step 705, and proceeds to step 760 when the CPU makes a “No” determination at step 705. In this manner, the neutral position notification is carried out.

Drive controls of the first motor generator MG1, the second motor generator MG2, and the engine 20 will next be briefly described. It should be noted that the details of those drive controls are described in, for example, Japanese Patent Application Laid-Open (kokai) No. 2009-126450 (US Patent Publication No. US2010/0241297), and Japanese Patent Application Laid-Open (kokai) No. Hei 9-308012 (U.S. Pat. No. 6,131,680, filed on Mar. 10, 1997), and so on. Those are incorporated herein by reference.

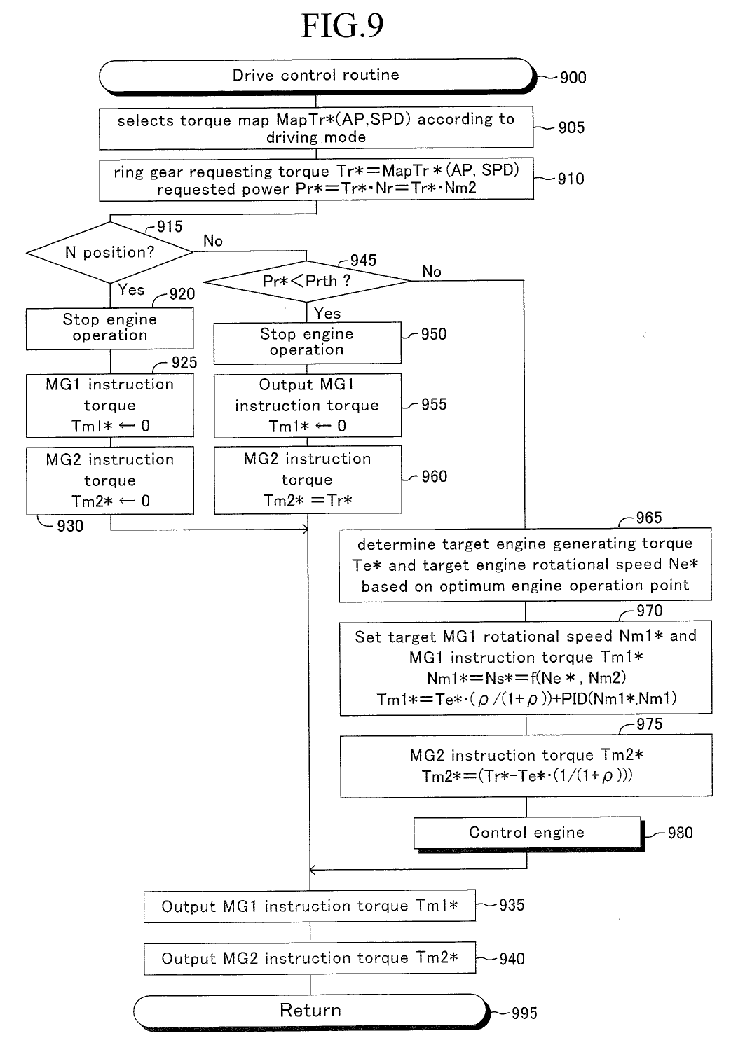

The CPU is configured so as to execute a “drive control routine” shown by a flowchart in FIG. 9, every elapse of a predetermined time. Accordingly, at an appropriate point in time, the CPU starts processing from step 900 of FIG. 9 to execute processes at steps described below.

Step 905: The CPU selects a torque map MapTr*(AP,SPD) corresponding to the currently selected driving mode (the power mode, the normal mode, and the economy mode).

Step 910: The CPU applies the current/present “accelerator operation amount AP and vehicle speed SPD” to the selected torque map MapTr*(AP,SPD) so as to determine the ring gear requesting torque Tr*.

Step 915: The CPU determines whether or not the current/present shift position is the neutral position. When the current shift position is the neutral position (and, a parking position), the CPU proceeds to step 920.

Step 920: The CPU sends an instruction signal to stop the operation of the engine 20 to the engine ECU. As a result, supplying the fuel to the engine 20 is stopped, so that the operation of the engine 20 is stopped and the engine rotational speed becomes “0.”

Step 925: The CPU sets the MG1 instruction torque Tm1* to/at “0.”

Step 930: The CPU sets the MG2 instruction torque Tm2* to/at “0.”

Step 935: The CPU sends the MG1 instruction torque Tm1* to the motor ECU 83. The motor ECU 83 controls the first inverter 61 based on the MG1 instruction torque Tm1* so as to control the torque generated by the first motor generator MG1. Note that, when the MG1 instruction torque Tm1* is “0”, no electric power is supplied to the first motor generator MG1.

Step 940: The CPU sends the MG2 instruction torque Tm2* to the motor ECU 83. The motor ECU 83 controls the second inverter 62 based on the MG2 instruction torque Tm2* so as to control the torque generated by the second motor generator MG2. Note that, when the MG2 instruction torque Tm2* is “0”, no electric power is supplied to the second motor generator MG2.

When the current shift position is not the neutral position, the CPU proceeds to step 945 from step 915 so as to determine whether or not the requested power Pr* is smaller than a predetermined power Prth (in other words, whether or not the current state is a state in which the engine 20 cannot be operated at the optimum engine operation point). At this point in time, if the requested power Pr* is smaller than the predetermined power Prth, the CPU executes processes from step 950 to step 960 described below, and thereafter, executes the processes of step 935 and step 940.

Step 950: The CPU sends an instruction signal to stop the operation of the engine 20 to the engine ECU. As a result, supplying the fuel to the engine 20 is stopped, so that the operation of the engine 20 is stopped.

Step 955: The CPU sets the MG1 instruction torque Tm1* to/at “0.”

Step 960: The CPU sets the MG2 instruction torque Tm2* to/at the ring gear requesting torque Tr*.

When the current shift position is not the neutral position and the requested power Pr* is equal to or larger than a predetermined power Prth, the CPU makes a “No” determination at step 945 to execute processes from step 965 to step 980 described below, and thereafter, executes the processes of step 935 and step 940.

Step 965: As described above, the CPU determines the target engine generating torque Te* and the target engine rotational speed Ne* based on the optimum engine operation point corresponding to the requested power Pr*.

Step 970: The CPU calculates the target rotational speed Ns* of the sun gear 32 (that is, target MG1 rotational speed Nm1*) by assigning the second MG rotational speed Nm2 which is equal to the rotational speed Nr of the ring gear 34, and the target engine rotational speed Ne* as the engine rotational speed Ne to the formula (1) described above. Further, the CPU calculates the MG1 instruction torque Tm1* by adding the feedback amount PID (Ns*−Nm1)=PID(Nm1*−Nm1) which corresponds to a difference between “the target MG1 rotational speed Nm1* and the actual rotational speed Nm1 of the first motor generator MG1” to the value calculated according to the above formula (2).

Step 975: The CPU determines the MG2 instruction torque Tm2* based on the above described formula (3) and the above described formula (4). It should be noted that the CPU may determine the MG2 instruction torque Tm2* based on a formula (5) described below.

Tm2=Tr*−Tm1*/ρ(5)

Step 980: The CPU sends an instruction signal to the engine ECU

84 such that the engine 20 is operated at the optimum engine operation point (in other words, the engine generating torque coincides with the target engine generating torque Te*).

As described above, the hybrid vehicle 10 according to the present embodiment having, as the driving source, the internal combustion engine 20 and the electric motor (second motor generator MG2), comprises, the shift position selecting section (the shift position sensor 92, the shift lever, and the like), the driving mode selecting section (the driving mode selection switch 91), the accelerator operation amount detecting section (the accelerator operation amount sensor 93), the drive control section, and the shift position information supplying section.

The drive control section is configured to:

control the engine and the electric motor so as to apply a driving torque which varies in accordance with the driving mode selected by the driving mode selecting section and becomes larger as the detected accelerator operation amount becomes larger to the drive axle connected to drive wheels of the vehicle, when the driving position is selected (refer to step 905, step 910, the “No” determination at step 915, steps from step 945 to step 980, step 935, and step 940); and

control the engine and the electric motor in such that no driving torque is applied to the drive axle, and the rotational speed of the engine becomes zero or a rotational speed irrelevant to the detected accelerator operation amount, regardless/irrespective of the detected accelerator operation amount, when the neutral position is selected (refer to the “Yes” determination at step 915 shown in FIG. 9, steps from step 920 to step 930, step 935, and step 940).

The shift position information supplying section is configured to supply information regarding the shift position to the driver, when the neutral position is selected and the detected accelerator operation amount becomes equal to or larger than the accelerator operation amount threshold (refer to step 750 and step 755, shown in FIG. 7).

Further, the shift position information supplying section is configured to set the first accelerator operation amount threshold (APnrm) which is the accelerator operation amount threshold set when the first driving mode (e.g., the normal mode) is selected to/at a value larger than the second accelerator operation amount threshold (APpwr) which is the accelerator operation amount threshold set when the second driving mode (e.g., the power mode) is selected (refer to steps from step 715 to step 735 shown in FIG. 7, and FIG. 2).

Accordingly, the appropriate driving torque can be applied to the drive axle 53 irrespective (regardless) of the driving mode, even when the shift position is changed from the neutral position to the driving position immediately after the neutral position notification was made while the neutral position was selected and when the accelerator operation amount was increased. Thus, the hybrid vehicle 10 can smoothly be started and/or accelerated.

The present invention is not limited to the embodiments described above, various modifications may be adopted within a scope of the present invention. For example, a drive system for the hybrid vehicle is not limited to the type of the above embodiment. That is, the hybrid vehicle may be a vehicle, which comprises, as the driving source, an internal combustion engine and an electric motor, and which is configured so as to generate a driving torque at the drive axle in accordance with at least the accelerator operation amount when the driving position is selected; and so as to stop the electric motor, release a clutch provided between the drive axle and the engine, and control the engine rotational speed to a predetermined value which is irrelevant with the accelerator operation amount when the neutral position is selected.

Further, in the above described embodiment, the accelerator operation amount threshold is set such that the value Tst is the constant value regardless of the driving mode, however, “each accelerator operation amount threshold for each driving mode” may be determined such that the values Tst are different from each other depending on the driving mode as long as the acceleration shock does not occur. In addition, the correction of the accelerator operation amount threshold by the vehicle speed correction amount of threshold ΔAPspd may be omitted (that is, the vehicle speed correction amount of threshold ΔAPspd may always be “0”). Furthermore, the vehicle speed correction amount of threshold ΔAPspd may be varied depending on the selected driving mode. Moreover, the accelerator operation amount threshold APth may directly be obtained base on the vehicle speed SPD and the selected driving mode using a table defining a “relationship between the selected driving mode, the vehicle speed SPD, and the accelerator operation amount threshold APth.”

The detected accelerator operation amount AP may be an amount of displacement of a member for inputting an acceleration request by the driver, such as an acceleration lever (e.g., joystick). The neutral position notification may be made using the sound device 72 only, or using the display by the message indicator 73 only. In addition, the neutral position notification may be carried out by changing a color of a letter “N” in the shift position indicator 74, or by blinking the letter “N.” In addition, when a temperature THW of the coolant water of the engine 20 is lower than a coolant water temperature threshold THWth, and thus, it is necessary to expedite warming up of the catalyst, or the like, the CPU may set the engine rotational speed Ne to/at a constant value (idling rotational speed) irrelevant with the acceleration operation amount, and retard an ignition timing of the engine 20.

1. A hybrid vehicle having, as a driving source, an internal combustion engine and an electric motor comprising;
a shift position selecting section configured to enable a driver to select, as a shift position, at least either one of a neutral position and a driving position;
a driving mode selecting section configured to enable said driver to select one of two or more of driving modes;
an accelerator operation amount detecting section configured to detect an accelerator operation amount which is varied by said driver;
a drive control section configured to control said engine and said electric motor so as to apply a driving torque, which varies depending on said driving mode selected by said driving mode selecting section and becomes larger as said detected accelerator operation amount becomes larger, to a drive axle connected to drive wheels of said vehicle, when said driving position is selected; and to control said engine and said electric motor in such a manner that no driving torque is applied to said drive axle, and a rotational speed of said engine becomes zero or a rotational speed irrelevant to said detected accelerator operation amount, irrespective of said detected accelerator operation amount, when said neutral position is selected; and
a shift position information supplying section configured to supply predetermined information regarding said shift position to said driver, when said neutral position is selected and said detected accelerator operation amount becomes equal to or larger than an accelerator operation amount threshold,
wherein,
said shift position information supplying section is configured to vary said accelerator operation amount threshold in accordance with said selected driving mode.

2. The hybrid vehicle according to claim 1, wherein,
said two or more of said driving modes include a first driving mode and a second driving mode, and said second driving mode is a driving mode in which said driving torque larger than said driving torque applied to said drive axle in said first mode is applied to said drive axle, when said driving position is selected and said accelerator operation amount is equal to an arbitrary accelerator operation amount, and
said shift position information supplying section is configured to set a first accelerator operation amount threshold which is said accelerator operation amount threshold to be set when said first driving mode is selected at a value larger than a second accelerator operation amount threshold which is said accelerator operation amount threshold to be set when said second driving mode is selected.

3. The hybrid vehicle according to claim 2, wherein,
said shift position information supplying section is configured to set said first accelerator operation amount threshold and said second accelerator operation amount threshold, in such a manner that:
said driving torque applied to said drive axle when said accelerator operation amount becomes equal to said first accelerator operation amount threshold in a case where said first driving mode is selected and said driving position is selected, and
said driving torque applied to said drive axle when said accelerator operation amount becomes equal to said second accelerator operation amount threshold in a case where said second driving mode is selected and said driving position is selected,
are equal to each other.

4. The hybrid vehicle according to claim 1, further comprising a vehicle speed detecting section configured to detect a vehicle speed which is a speed of said vehicle, and wherein,
said drive control section is configured to control said engine and said electric motor in such a manner that said driving torque becomes smaller as said detected vehicle speed becomes higher, when said driving position is selected; and
said shift position information supplying section is configured so as to vary said accelerator operation amount threshold in such a manner that said accelerator operation amount threshold becomes larger as said detected vehicle speed becomes higher.
